(19) United States
(12) Patent Application Publication
(10) Pub. No.: US 2016/0345074 A1
(43) Pub. Date: Nov. 24, 2016

(54) Apparatus and Method for Replacing Conventional Commercials with Targeted Advertisements in Online Live Streams

(71) Applicant: Viviso Inc., Sunnyvale, CA (US)

(72) Inventors: Seyitali Serbest, San Francisco, CA (US); Soner Can, Santa Clara, CA (US)

(73) Assignee: Viviso Inc., Sunnyvale, CA (US)

(21) Appl. No.: 15/161,057

(22) Filed: May 20, 2016

Related U.S. Application Data
(60) Provisional application No. 62/165,149, filed on May 21, 2015.

(51) Int. Cl. H04N 21/81; H04N 21/482; H04L 29/08; H04N 21/234; H04L 29/06

(52) U.S. Cl. CPC H04N 21/812; H04N 21/23424; H04L 65/608; H04L 67/02; H04N 21/4825

(57) ABSTRACT

A method and apparatus for performing user-targeted advertisement replacement for HTTP live streams includes receiving a content request from a client, generating a content stream playlist file and video segment URIs based on Unix (Epoch) time information of request time corresponding to the content stream playlist file generated by a content delivery network without sending any HTTP requests to the content delivery network. A VAST request is sent from a server side application to receive a targeted VAST creative M3U8 playlist. User-targeted advertisement blocks based on predetermined advertisement start/end times saved on a database are prepared. Alternately, an HTTP trigger performed by the broadcaster and using VAST creative in M3U8 format is asynchronously pulled from an advertisement server. The M3U8 playlist contains both a content stream and an advertisement playlist. Tracking data is collected at the server side for served advertisement playlists to the client.

### CROSS-REFERENCE TO RELATED APPLICATION

This application claims priority to U.S. Provisional Patent Application Ser. No. 62/165,149, filed May 21, 2015, the contents of which are incorporated herein by reference.

### FIELD OF THE INVENTION

This application relates generally to streaming of content in a network environment. More particularly, this invention relates to techniques for replacing conventional commercials with targeted advertisements in online live streams.

### BACKGROUND OF THE INVENTION

Streaming media is multimedia that is constantly received by and presented to an end-user while being delivered by a provider. The verb “to stream” refers to the process of delivering media in this manner; the term refers to the delivery method of the medium, rather than the medium itself, and is an alternative to file downloading.

A client media player can begin to play the data (such as a movie) before the entire file has been transmitted. Distinguishing delivery method from the media distributed applies specifically to telecommunications networks, as most of the delivery systems are either inherently streaming (e.g., radio, television) or inherently non-streaming (e.g., books, video cassettes, audio CDs). Today, Internet television is a common form of streamed media.

In the case of streamed media, the user of a streaming media device may develop an online profile manifesting interests and preferences. Accordingly, it would be desirable to provide targeted advertisements to such a user.

### SUMMARY OF THE INVENTION

A method and apparatus for performing user-targeted advertisement replacement for HTTP live streams includes receiving a content request from a client, generating a content stream playlist file and video segment URIs based on Unix (Epoch) time information of request time corresponding to the content stream playlist file generated by a content delivery network without sending any HTTP requests to the content delivery network. A VAST request is sent from a server side application to receive a targeted VAST creative M3U8 playlist. User-targeted advertisement blocks based on predetermined advertisement start/end times saved on a database are prepared. Alternately, an HTTP trigger performed by the broadcaster and using VAST creative in M3U8 format is asynchronously pulled from an advertisement server. The M3U8 playlist contains both a content stream and an advertisement playlist. Tracking data is collected at the server side for served advertisement playlists to the client.

### BRIEF DESCRIPTION OF THE FIGURES

The invention is more fully appreciated in connection with the following detailed description taken in conjunction with the accompanying drawings, in which:

FIG. 1 illustrates a system for dynamic user targeted video advertisement insertion into an online live video stream.

FIG. 2 illustrates merging VOD HLS manifest files into a single combined manifest file in accordance with an embodiment of the invention.

FIG. 3 illustrates a machine configured in accordance with an embodiment of the invention.

FIG. 4 illustrates dynamic window sliding methodology of the playlist generator during advertisement breaks.

Like reference numerals refer to corresponding parts throughout the several views of the drawings.

### DETAILED DESCRIPTION OF THE INVENTION

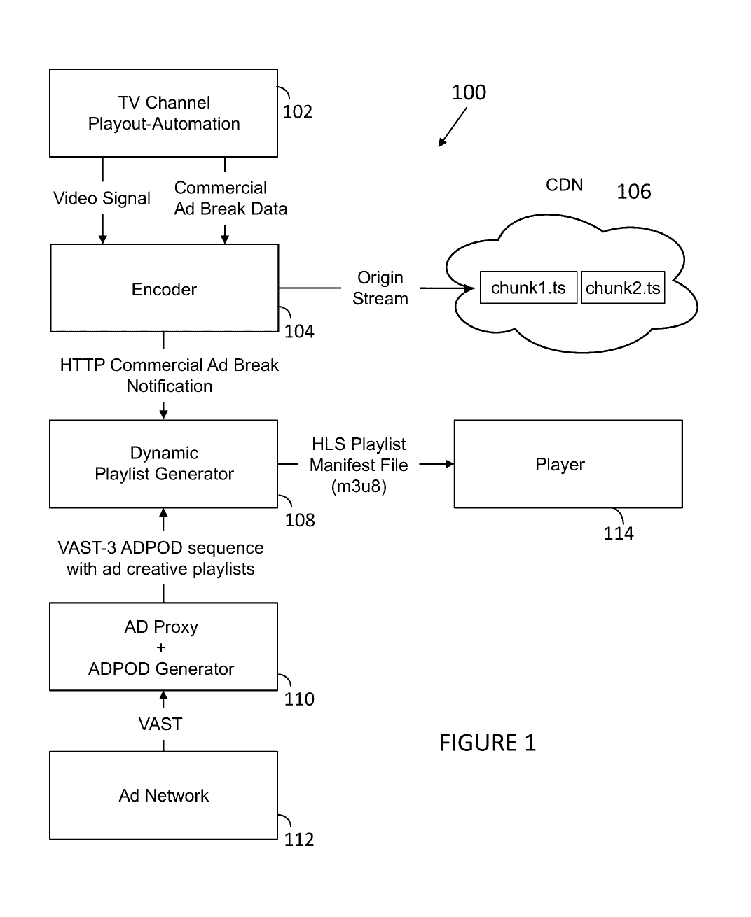

FIG. 1 illustrates a system 100 configured in accordance with an embodiment of the invention. The system 100 includes a television channel payout-automation software/hardware system 102 that generates video signals and commercial advertisement break data which is sent to an encoder 104. The encoder 104 uploads a received video stream to a Content Delivery Network (CDN) 106 and it sends notifications to a dynamic playlist generator 108 when it receives any advertisement break in and advertisement break out signals from the TV channel 102. When an advertisement break is detected, the dynamic playlist generator 108 sends a request to an advertisement proxy 110 to have it send multiple Digital Video Advertisement Serving Template (VAST) requests to at least one advertisement network 112. The advertisement proxy 110 receives VAST responses from the advertisement network 112. In one embodiment, the advertisement proxy 110 transcodes received content to HTTP Live Stream (HLS) compatible playlist manifest files and video segments. For example, the manifest files may be in a M3U8 format. M3U is a computer file format for a multimedia playlist. M3U8 is the Unicode version of M3U, which uses UTF-8 encoded characters. The advertisement proxy 110 merges created HLS playlist files into one playlist manifest file and creates a VAST response for the dynamic playlist generator 108, including an advertisement pod which contains all creative files received via separate Hyper Text Transfer Protocol (HTTP) requests sent to advertisement network 112.

Player 114 is video client software that periodically sends requests to the dynamic playlist generator 108. If the dynamic playlist generator 108 has an advertisement break insertion signal in record at the time of the request from the player 114, it replaces a television network commercial advertisement break containing playlist manifest files with user targeted video advertisements containing playlist manifest files. The player 114 receives all HLS playlist manifest files from the dynamic playlist generator 108 and video segments/chunks from CDN 106. The dynamic playlist generator 108 keeps track of which player 114 receives which generated playlist files and when it is done.

HTTP Live Streaming is a media streaming protocol which uses a computer file format containing Uniform Resource Identifiers (URI). HTTP Live Stream Playlist Manifest Files (M3U8) deliver both Video on Demand (VOD) and live video streams from servers to online users. M3U8 files are simple text files containing sequentially listed URI's for small video files, which are called video segments or chunks. A video client periodically sends requests to the server to receive updated M3U8 files. After reception of a playlist manifest file, a video client downloads each media file using URI's inside the playlist. Time interval of playlist file requests is equal to #EXT-X-TARGETDURATION, which is a required tag inside of each M3U8 file. On each request, one newly generated video segment's URI is appended to the next M3U8 file as the last segment, while the first video segment on the list is optionally removed from the list. Another required tag is #EXT-X-MEDIA-SEQUENCE, which is the value of a newly generated M3U8; the value is increased by 1 on each video segment URI removal in M3U8. Since video segments are small files in size, it doesn't take too long for a video client to download and play them. HLS enables clients to view videos seamlessly.

The first phase of the method receives a conventional television network broadcast in a digital format such as Serial Digital Interface (SDI), Digital Video Broadcasting (DVB), Real Time Messaging Protocol (RTMP) or HLS from the television channel 102 and encoder 104. During the reception of the stream, the encoder 104 uploads the television network stream to a CDN 106 and continuously inspects the stream to find advertisement break in and advertisement break out times. This data is required to replace television commercials with targeted video advertisements. This inspection is done in different ways depending on advertisement break notification capabilities of the television network 102.

One inspection method is for SCTE-35 embedded into a video stream. The Society of Cable Telecommunication Engineers Protocol 35 (SCTE-35) is a standard to mark advertisement break in and out timing information in an MPEG transport stream file. If the stream received from a TV network has SCTE-35 data embedded, this data is used to know advertisement break in and out times.

Another inspection method is image recognition. The stream received from the television network 102 is continuously analyzed using an image recognition software/algorithm. When an advertisement break in or out is detected, the dynamic playlist generator 108 is triggered by Application Program Interface (API) calls via HTTP requests.

Another inspection method is HTTP triggers from an automation system of a television network. Television network automation systems have the capability to send API calls at certain events happening at the broadcast playlist (such as logo changes when an advertisement break comes in and out). This ability is used to notify the dynamic playlist generator 108 when an advertisement break starts and ends.

An advertisement break schedule may also be entered manually by an editor. Using a web interface, an editor enters advertisement break in and out time information to the system. Then, the system constantly sends notifications to the dynamic playlist generator 108 to let it know when the advertisement break starts and ends.

The second phase of the method is generation and manipulation of the M3U8 files for respective clients. Dynamic playlist generator 108 is the essential part of this phase. The dynamic playlist generator 108 is a proxy server between CDN 106 and video clients 114. With a regular HLS video stream scenario, a video client connects to CDN 106 and it directly receives the M3U8 files and all segment files included with them. The method places itself between the client 114 and the CDN 106; this enables the method to manipulate both M3U8 files and video segments inside them.

All HLS compatible video clients send recurring requests after each #EXT-X-TARGETDURATION value passes. The dynamic playlist generator 108 receives all requests from the video clients. In order for the dynamic playlist generator 108 to replace television commercials and insert targeted video advertisements, the online video stream is required to be delayed compared to real time TV broadcast run time. That means there is an unpreventable time offset to be set for advertisement ingestion into a live stream. This is also a requirement because of the structure of HLS manifest files (M3U8).

With each request, the following happens. If the time of playlist delivery is not equal to a scheduled/triggered/signaled advertisement break time and not equal to advertisement preparation time, the dynamic playlist generator 108 creates a regular stream M3U8 file and delivers it to client 114. An advertisement break status check is done at all of the requests coming to the dynamic playlist generator 108.

If the time of delivery is equal to the advertisement preparation time, the dynamic playlist generator 108 starts a multiphase process. The formula for advertisement preparation time is:

APT=(CT−PTO)
APT=Advertisement Preparation Time
CT=Current Time
PTO=Advertisement Preparation Time Offset Value

For the current time to be equal to the advertisement preparation time, the dynamic playlist generator 108 splits the last video segment which is a media file before the advertisement break comes in to make the advertisement appear on time. For example, below is a sample HLS manifest for a live stream:

#EXTM3U
#EXT-X-TARGETDURATION:10
#EXT-X-VERSION:3
#EXT-X-MEDIA-SEQUENCE:143094623
#EXTINF: 10.000,
segment143094623.ts
#EXTINF: 10.000,
segment143094624.ts
#EXTINF: 10.000,
segment143094625.ts

Segments are named as 10 seconds of Unix Epoch Time values in a way to represent content time. For example, segment143094625 means that this video segment contains 10 seconds of video of live stream corresponding to the date between Wed, 6 May 2015 21:04:10 Greenwich Mean Time (GMT) and Wed, 6 May 2015 21:04:19 GMT. #EXTINF:10 represents total duration of the segment.

When the dynamic playlist generator 108 receives a trigger/signal to replace television commercials between Wed, 6 May 2015 21:04:53 GMT and Wed, 6 May 2015 21:05:23 GMT that means the video segment before the advertisement break will show. In this case segment143094629 should be split. There are some on premise solutions to create this segment during the encoding process using SCTE35 signals. On the other hand, one embodiment covers this requirement with a cloud based technology without queuing data.

The dynamic playlist generator 108 fetches segment143094629 from the CDN and splits this 10 seconds TS file into 2 pieces starting from the point of advertisement break in time. The resulting video segment is named in the same way (segment143094629), but now it contains only 3 seconds of video. Depending on the particular encoding settings during split, a #EXT-X-DISCONTINUITY tag can be required. However, the splitting technology bypasses this requirement by synchronizing pts_start_time of the split segment with the source segment. So the final content of the next M3U8 file is:

#EXTM3U
#EXT-X-TARGETDURATION:10
#EXT-X-VERSION:3
#EXT-X-MEDIA-SEQUENCE:143094627
#EXTINF: 10.000,
segment143094627.ts
#EXTINF: 10.000,
segment143094628.ts
#EXTINF:3.000,
segment143094629.ts // Split segment

The same splitting operation is performed for the segments that are placed at the end of the advertisement segments. This time, the segment is split starting from a proper key frame. Splitting technology allows ingesting those segments without using any EXT-X-DISCONTINUITY tags at the intersection points with the live stream segments.

After splitting the last video segment to be viewed just before the first video of the advertisement break, the dynamic playlist generator 108 requests a targeted VAST response (including advertisement pods data) from the advertisement proxy 110. In one embodiment, the response is in Digital Video Ad Serving Template Version 3 (VAST3.0) format and contains targeted video advertisement data blocks, which have information about the advertisement videos to be served to the client 114.

The duration of a conventional advertisement break and the duration of the personalized advertisement pods are not the same due to platform differences. A fetched advertisement pod from an advertisement network 112 can be shorter or longer in length than the duration of the conventional advertisement break.

The method resolves this problem by keeping the record of the difference between conventional advertisement break length and each client's personalized advertisement pod's total length. This data is used to fix the possible timing issues in subsequent advertisement breaks and/or as content streams. For example, Conventional Advertisement Break #1's duration for Channel A is exactly 6 minutes. For this particular advertisement break, personalized user-targeted advertisement pod's duration for Client #1 is 6 minutes and 10 seconds; for Client #2 it is 6 minutes and 15 seconds; for Client #3 it is 6 minutes and 7 seconds. Under these circumstances, none of the mentioned clients are able to resume Channel A's live stream accurately after the conventional advertisement break of 6 minutes. As a result, the content stream may be resumed just in time ignoring the client specific conditions, Channel A's content stream after the advertisement break will already be on air for the time of following offset values: 10 seconds for Client #1, 15 seconds for Client #2 and 7 seconds for Client #3. This interruption of the user experience is not acceptable.

The resumption of the content stream may be delayed for the time of offset values of each client. While this method works to avoid interruption of the user experience, it causes another problem for subsequent advertisement breaks and it breaks the consistency of the content stream timing. If there are advertisement breaks exceeding conventional advertisement break time subsequently, the time gap will increase between the actual stream timestamp of Channel A and the online live stream of it, break-by-break.

One embodiment of the method resolves this problem by keeping track of the time difference between each conventional advertisement break and each personalized user-targeted advertisement pod length and uses the data to re-arrange prospective M3U8 playlists.

Returning to the example above, when an advertisement break is triggered by TV broadcaster 102, the system checks for the previous advertisement break and advertisement pod duration data. If the client was previously served a longer advertisement pod compared to the conventional advertisement break, the next advertisement duration requested from the advertisement network will be for the time equal to the current duration minus the previous offset value. A mismatch between a conventional advertisement break and advertisement pod length may be expressed as:

T=(Cd−Po)

Where T is the resulting duration to be requested for a new advertisement pod for a particular client, Cd is the current expected duration of a conventional advertisement break, Po is the offset value for a particular client that existed at the previous advertisement break.

After the Conventional Ad Break #1 particular time differences exist for the clients. In the case of an Ad Break #2 of 5 minutes in length, each client will request a different amount of time. In particular, the requests will be 4 minutes and 50 seconds for Client #1, 4 minutes and 45 seconds for Client #2 and 4 minutes and 53 seconds for Client #3. These values are requested from the advertisement network. This method eliminates the risk of an increasing time gap between conventional advertisement break duration and personalized user-targeted online live stream advertisement duration.

The VAST3.0 response received from the advertisement proxy 110 contains more than one advertisement and there is one creative URI for each video. Video advertisements' creative files which are received from the advertisement proxy 110 are also in the HLS format. On the other hand, the dynamic playlist generator 108 takes several actions in order to ingest all of the advertisement videos to the live stream. First, the dynamic playlist generator 108 sends HTTP requests to creative URIs to retrieve content which will be merged and added to the manipulated advertisement break sequence.

According to HLS specifications, content of a VOD HLS manifest file cannot be directly injected into a live stream manifest file. The sample above is not appropriate to be added into a live stream manifest file as it is. Therefore, after receiving M3U8 file content for each creative the dynamic playlist generator 108 merges them by extracting only #EXTINF and URI parts of the content and adding them one by one in the order they appear in the VAST response.

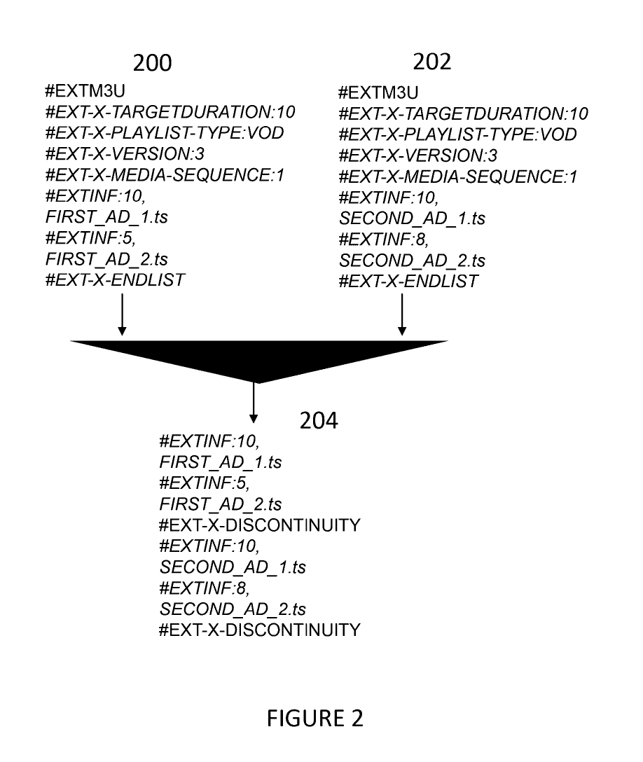

Merged advertisement segments are not ready to play inside a live HLS stream unless forbidden tags (e.g., #EXT-X-PLAYLIST-TYPE:VOD, #EXT-X-ENDLIST) are removed and required tags (e.g., #EXTM3U, #EXT-X-MEDIA-SEQUENCE, #EXT-X-TARGETDURATION and #EXT-X-VERSION) are present. A #EXT-X-DISCONTINUITY tag is added to the end of each advertisement to facilitate smooth video playing. FIG. 2 provides an example of the merging of two files. More particularly, the figure illustrates the merging of VOD HLS manifest files 200 and 202 into a single combined manifest file 204.

The dynamic playlist generator 108 makes some calculations depending on previously received advertisement break start and finish times. It finds and splits the live stream segments to coincide with start and finish times and encapsulates the advertisement break with newly generated segments. Thus, advertisements are spliced to the live steam frame accurately. Also, the dynamic playlist generator 108 arranges advertisement segments, puts them in order and makes them available for serving. If the player 114 requests an HLS manifest file at the time which is in between advertisement related time range, these segments are served. The advertisement related time formula is as follows:

ART={(ABI−SC) . . . (ABI+ASC+1)}
ART=Advertisement Related Time range
ABI=Advertisement Break start time in 10 seconds
SC=Segment count of live stream playlist
ASC=Total Advertisement Segments count

An example use case of previously prepared segments follows. If the advertisement break start time is 1430946293 in Unix Epoch Time, the dynamic playlist generator 108 prepares the following segments and stores them in a database:

| Segment URL | Segment Duration | Segment Type |
|---|---|---|
| segment143094627.ts | 10 | Live stream segment |
| segment143094628.ts | 10 | Live stream segment |
| segment143094629.ts | 3 | Trimmed segment |
| FIRST_AD_1.ts | 10 | Advertisement segment |
| FIRST_AD_2.ts | 5 | Advertisement segment |
| SECOND_AD_1.ts | 10 | Advertisement segment |
| SECOND_AD_2.ts | 8 | Advertisement segment |
| segment143094632.ts | 4 | Trimmed segment |

The dynamic playlist generator 108 serves the playlists as requested in the following order.

| Playlist 1 | Playlist 2 |
|---|---|
| #EXTM3U | #EXTM3U |
| #EXT-X-TARGETDURATION:10 | #EXT-X-TARGETDURATION:10 |
| #EXT-X-VERSION:3 | #EXT-X-VERSION:3 |
| #EXT-X-MEDIA-SEQUENCE:143094627 | #EXT-X-MEDIA-SEQUENCE:143094628 |
| #EXTINF:10.000, | #EXTINF:10.000, |
| segment143094627.ts | segment143094628.ts |
| #EXTINF:10.000, | #EXTINF:3.000, |
| segment143094628.ts | segment143094629.ts |
| #EXTINF:3.000, | #EXT-X-DISCONTINUITY |
| segment143094629.ts | #EXTINF:10.000, |
| | FIRST_AD_1.ts |
| Playlist 3 | Playlist 4 |
| #EXTM3U | #EXTM3U |
| #EXT-X-TARGETDURATION:10 | #EXT-X-TARGETDURATION:10 |
| #EXT-X-VERSION:3 | #EXT-X-VERSION:3 |
| #EXT-X-MEDIA-SEQUENCE:143094629 | #EXT-X-MEDIA-SEQUENCE:143094630 |
| #EXTINF:3.000, | #EXTINF:10.000, |
| segment143094629.ts | FIRST_AD_1.ts |
| #EXT-X-DISCONTINUITY | #EXTINF:5.000, |
| #EXTINF:10.000, | FIRST_AD_2.ts |
| FIRST_AD_1.ts | #EXT-X-DISCONTINUITY |
| #EXTINF:5.000, | #EXTINF:10.000, |
| FIRST_AD_2.ts | SECOND_AD_1.ts |
| Playlist 5 | Playlist 6 |
| #EXTM3U | #EXTM3U |
| #EXT-X-TARGETDURATION:10 | #EXT-X-TARGETDURATION:10 |
| #EXT-X-VERSION:3 | #EXT-X-VERSION:3 |
| #EXT-X-MEDIA-SEQUENCE:143094631 | #EXT-X-MEDIA-SEQUENCE:143094632 |
| #EXTINF:5.000, | #EXTINF:10.000, |
| FIRST_AD_2.ts | SECOND_AD_1.ts |
| #EXT-X-DISCONTINUITY | #EXTINF:8.000, |
| #EXTINF:10.000, | SECOND_AD_2.ts |
| SECOND_AD_1.ts | #EXT-X-DISCONTINUITY |
| #EXTINF:8.000, | #EXTINF:4.000, |
| SECOND_AD_2.ts | segment143094634.ts |

Sliding playlists that consist of segments with fixed TARGET DURATION is described in early stages of this document. In each request a new segment URL is appended to the playlists and optionally one or more segment URL(s) is/are removed from the top while incrementing MEDIA SEQUENCE ID by number of removed segments. As advertisement segments are injected to the playlist, segment durations will not be fixed and not equal to TARGET DURATION. Another embodiment of the invention is preparing a playlist with a variable number of additions and removals of segments, to create a dynamic sliding window. In this method, the number of segments in the different playlists does not need to be same, but total playlist durations are kept as similar as possible and greater than or equal to a threshold.

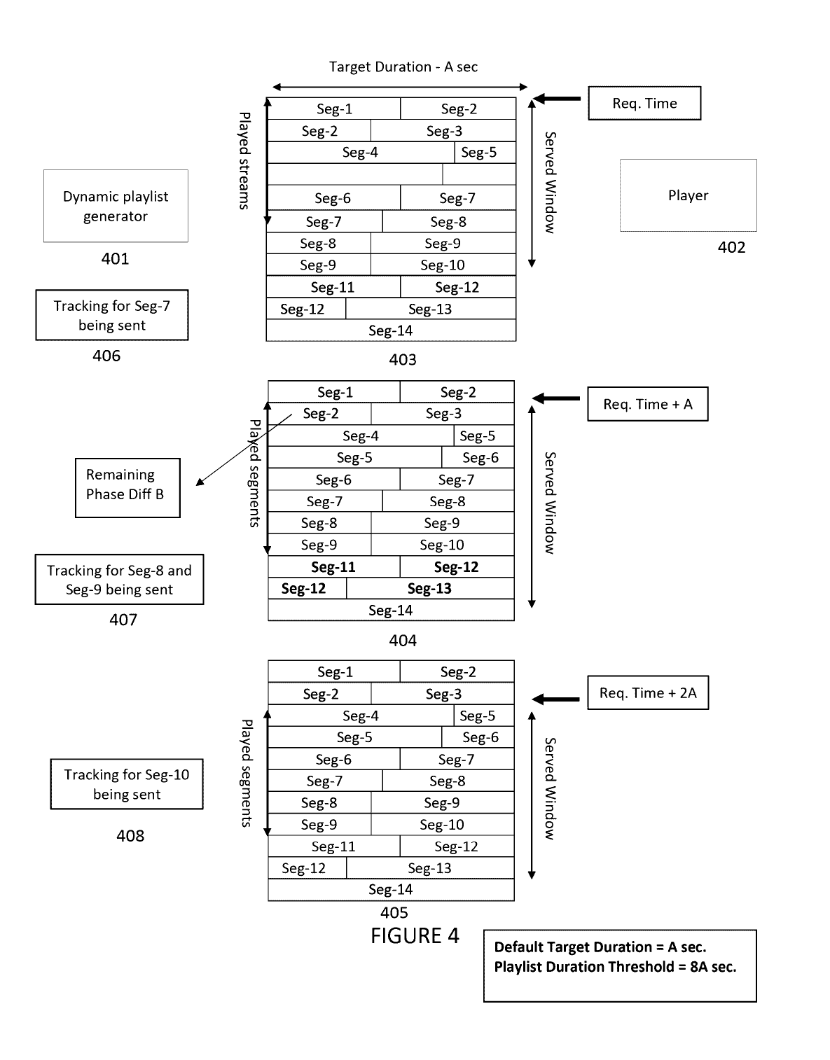

FIG. 4 depicts an example of varied playlists. The dynamic playlist generator 401 generates playlists with EXT-X-TARGETDURATION of A seconds. Player 402 sends requests for a new playlist per A seconds. The dynamic playlist generator 401 stores the request time during the first request of the player 402 and responds with 10 segments. Total duration for the segments is 8A seconds.

In the next request of the player 402, dynamic playlist generator 401 again gets the current time and calculates the exact time difference between the current and previous request times. This value is called a phase difference. The dynamic playlist generator 401 subtracts top segment duration from phase difference while removing necessary segments from the previous playlist. This process continues until phase difference is a non-positive value. The dynamic playlist generator 401 keeps track of this user specific phase difference value in conjunction with the request time for making decisions for the following requests. The formula for the segment removing operation is:

PD+(CRT−PRT)<=DCS₁+ . . . +DCS_{N}
PD: Phase Difference remaining from the previous request
CRT: Current Request Time
PRT: Previous Request Time
DCSₓ: Duration of the Cleared Segment X
N: Total number of removed segments

In the second phase, the dynamic playlist generator 401 appends new segments to the playlist if the total duration of remaining segments is less than playlist duration threshold. During this operation, an EXT-X-DISCONTINUITY tag is used before new segments in case an advertisement ends and segments from another advertisement are intended to be injected into the playlist. Injection continues until a playlist duration threshold is satisfied. The formula for the second phase is:

(DRS₁+ . . . +DRS_{M})+(DAS₁+ . . . +DAS_{N})>=PDT
DRS: Duration of remaining segment
DAS: Duration of Added Segment
N: Total number of added segments
M: Total number of remaining segments
PDT: Playlist Duration Threshold

The player 402 requests another playlist after A seconds. Because we do not have a previously created phase difference, the total minimum duration for segment removal from the top of the current playlist is A seconds. The dynamic playlist generator 401 decides to remove Segment 1 and Segment 2 and stores value B (equals to DCS₁+DCS₂−A) as the phase difference which is a non-positive number. Now total duration of the remaining segments (DRS) is 7A+B. New segments are required to complete the duration of the playlist until total duration is greater than or equal to 8A. So Segment 11, Segment 12 and Segment 13 are appended to the playlist. Now its total duration is 9A+B and playlist 404 is ready to be served.

During the third request, the dynamic playlist generator 401 has B as phase difference and A as the request time difference. Duration of Segment 3 equals to A+B, which is why only removing this segment is enough for aligning with the request time. Also total duration of remaining segments is 8A and there is no need to add new segments to the end of the playlist. Segments from 4 to 13 are served as done in the playlist 405.

HLS compatible video players are expected to send recurring requests to any HLS server in a once per A seconds basis. However, this is not always the case. For example, during variant changes or first requests, players may send multiple requests and more frequent than A. Therefore, tracking request times is important to make all calculations correctly.

Sometimes TV networks may not have commercial breaks in their linear streams and they may prefer injecting targeted advertisements into transcoded online streams. Another embodiment of the invention is creating configurable advertisement breaks which originally do not exist in the linear stream of a TV network and seamlessly switching from a live stream to advertisements and then resuming a live stream from the next segment of the segment placed just before advertisement break. Thus, no channel stream is overridden by the advertisement segments. This method provides Video on Demand Style advertisement injection in HTTP Live Streams. Advertisement injection will cause the stream to be served with a delay. On the other hand, the dynamic playlist generator 401 keeps track of all streaming offsets for each user and promises serving without skipping any chunk of the stream.

The method also manages decision mechanism for the users who leave during advertisement breaks and come back after some time. Optionally, the dynamic playlist generator 401 serves remaining advertisements or starts serving from the live streams according to preferences. If remaining advertisements are continued to be served, returning point decision mechanism takes its place.

When the dynamic playlist generator 108 sends a request to the advertisement proxy 110 to fetch the necessary video advertisement data for each client, it responds with a VAST3.0 protocol including tracking URLs for each advertisement. During the generation and manipulation of the advertisement related playlist files, the dynamic playlist generator 108 saves tracking URL data of each video advertisement as well.

When the player 402 receives a playlist containing the last segment of a specific advertisement, it downloads the related segment and plays it. The dynamic playlist generator 108 notifies the advertisement proxy 110. This is a server-side tracking strategy. The Method uses server-side tracking because of its huge benefit, namely, removing dependency of any client side software to track advertisements. With client-side tracking users are required to have some kind of software stack, such as using a specific video player, enabling JavaScript, having some player related plug-ins etc. Server-side tracking does not have these requirements. If a video client is capable of playing an HLS stream properly, this is enough for a client to be tracked by server-side strategy.

Whether the current time for playlist delivery is in between the advertisement related time range or not, every video client request hits the dynamic playlist generator 401. If it is in the advertisement related time range, the dynamic playlist generator 108 delivers manipulated M3U8 playlist files. During this delivery, the dynamic playlist generator 401 knows which playlist is being sent and what it contains.

In already used HLS playlist preparation methodologies, specifying which segments are being played at a time requires gathering some information from a client site. On the other hand, the dynamic playlist generator 401 handles this ambiguous case by using a dynamic sliding window methodology.

The dynamic sliding window methodology is based on time shifting rather than relying on segment sliding or MEDIA SEQUENCE ID changes. A second approach works properly if durations of all segments are the same and are equal to EXT-X-TARGETDURATION. However, it has some problems when segment durations are inconsistent. The dynamic sliding window methodology keeps the playing position constant in terms of duration from top of the playlist rather than segment count. As a result, it knows which segment(s) has/have been completed at any request time. For the example case depicted in FIG. 4, the dynamic playlist generator 401, sends tracking information 406 (for Segment 7) after the first request, sends tracking information 407(for Segment 8 and Segment 9) after the second request and sends tracking information 407 (Segment 10) after the third request.

If a client consumes a targeted portion of the video advertisement, upon delivery of a related playlist file, the dynamic playlist generator 108 sends an HTTP request to the tracking URL which was in the VAST3.0 response received from the advertisement proxy 110. The HLS specification requires video clients to send recurring requests to a server every EXT-X-TARGETDURATION period (in seconds). This value is also strictly related to the duration of the longest video segment. As a result, the EXT-X-TARGETDURATION value is also a limitation for gathering tracking data from the client. For example, if the EXT-X-TARGETDURATION value is 10 seconds, it means the video client sends a new request once every 10 seconds. It practically means that after the dynamic playlist generator 108 delivers any playlist in the advertisement related time range there is a 10 seconds margin of error. The advertisement proxy 110 notifies the advertisement network 112 from where the client played the video advertisement.

Another embodiment of the invention comprises conversion of progressive video files received from any advertisement video advertisement network to the HLS format and adding them to a VAST3.0 compatible Ad Pod sequence, which is then served to the dynamic playlist generator 108. The dynamic playlist generator 108 requests a sequence of video advertisements from the advertisement proxy 110, which will fit the duration of the television advertisement break. In this case, the advertisement proxy 110 prepares a requested video sequence with two different strategies.

The first strategy is serving local advertisement inventories existing at the advertisement proxy 110. The advertisement proxy 110 is also an advertisement server that uses the VAST3.0 standard to respond to the requests that it receives. It can directly serve to the client advertisement orders and their dependent creative. Inventories and orders which are prepared by using the advertisement proxy 110 have HLS compatible creative by default. When a client requests a sequence of video advertisements in a specific duration, the advertisement proxy 110 calculates the most accurate scenario and returns a VAST3.0 response having an Ad Pod sequence.

The second strategy is to serve VAST advertisement networks' video advertisements by converting progressive video files into HLS compatible video files. As an alternative to serving local inventories, the advertisement proxy 110 fills a requested duration with video advertisements received from third party video advertisement networks.

At the time of this writing, the video advertisement market is broadly dependent on VOD advertisements. Because of this, a widely used format for advertisements is H.264 encoded MP4 files. These creative are served progressively by hosting CDNs 106. This file format works for most advertisement network consumers since they use mp4 creative to show them in VOD context and inside specific players/plug-ins that support VAST as pre-roll, mid-roll, and post-roll advertisements. But in terms of HLS compatibility, it is not possible to use any progressive MP4 file inside an HLS stream. The HLS specification requires a video to be split into compatible MPEG-TS files and to be served within M3U8 playlist manifest files.

At this point, the advertisement proxy 110 resolves the issue by placing itself as a proxy server between the client, its dynamic playlist generator 108 and advertisement networks 112. When a request is received by the advertisement proxy 110 for a sequence of video advertisements (VAST3.0 Ad Pod) corresponding to a particular duration time:
a) The advertisement proxy 110 sends requests to advertisement networks 112 to get individual VOD advertisements.
b) The advertisement proxy 110 calculates the length of gathered individual VOD advertisements and confirms that they are enough to fill expected duration time requested by the client.
c) The advertisement proxy 110 fetches creative URLs of each VOD advertisement from VAST responses returned from advertisement networks 112.
d) The advertisement proxy 110 downloads and transcodes VOD files into HLS compatible segments, creates M3U8 and uploads them to CDN 106. This is done for each advertisement. Resolution, aspect ratio and encoder types are specified. (If the creative was previously converted, this step is skipped)
e) Prepares a final VAST response which complies with VAST3.0 standards and creates an Ad Pod sequence using newly generated HLS versions of the advertisements as creative.
f) The advertisement proxy 110 returns final VAST to the client.

A conversion process performed by the advertisement proxy 108 is required for any VOD advertisement network advertisements to be ingested into an HLS stream, unless creative are already in the HLS format.

Those skilled in the art will appreciate that the components of FIG. 1 may be combined or further sub-divided. It should also be appreciated that all of the components share a network connection, such as an Internet network connection.

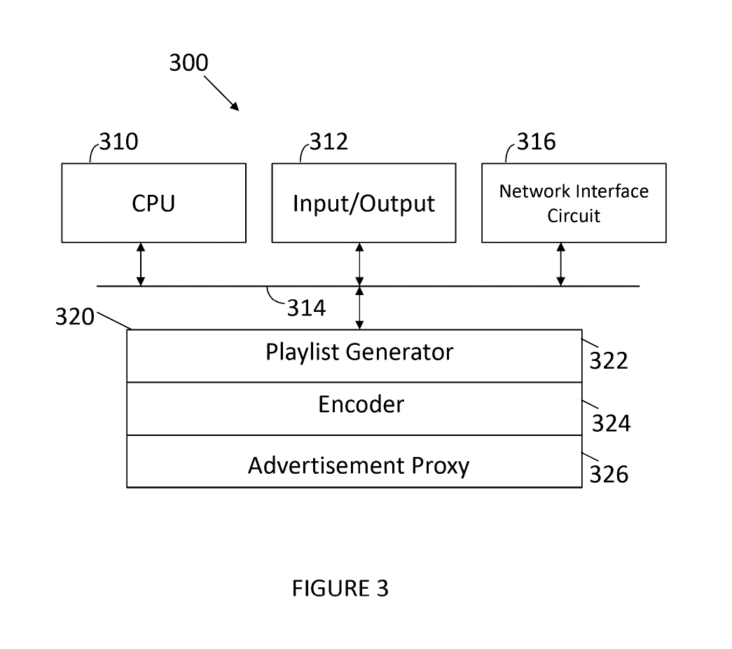

FIG. 3 illustrates a machine 300 that may be used to implement components of FIG. 1 in a separated or combined manner. The machine 300 includes standard components, such as a central processing unit 310 connected to input/output devices 312 via a bus 316. The input/output devices 312 may include a keyboard, mouse, touch display and the like. A network interface circuit 316 is also connected to the bus 314 and provides connectivity to any of the networks discussed herein. A memory 320 is also connected to the bus 314. The memory 320 stores instructions executed by the central processing unit 310 to implement operations disclosed herein. This machine may reside virtually in a cloud environment. For example, the instructions may include a playlist generator 322 operative to implement the operations discussed in connection with dynamic the playlist generator 108. The playlist generator 322 includes instructions executed by the CPU 310 to merge a first playlist file with a first advertisement playlist file to produce a combined playable live stream playlist file. The playlist generator 322 supplies required tags to the combined playlist file and removes forbidden tags from the advertisement play list file. In particular, the playlist generator 322 includes instructions executed by the CPU 310 to receive in and out notifications of the first advertisement break associated with content streamed over the network. Length of the first advertisement break is evaluated. A first targeted advertisement set is played. The content streamed over the network is delayed by a time offset corresponding to the amount of time that the first targeted advertisement set exceeds the first advertisement break duration. In and out notifications of the second advertisement break associated with the content streamed over the network are received. Duration of the second advertisement break is evaluated. A second targeted advertisement set with a duration of the second advertisement break duration minus the offset is obtained. The playlist generator 108 includes instructions executed by the CPU 310 to merge a first playlist file with a first advertisement playlist file to produce a combined playable live stream playlist file. The playlist generator 108 supplies required tags to the combined playlist file and removes forbidden tags from the advertisement play list file.

The memory 320 may also store an encoder 324 to implement the operations discussed in connection with encoder 104. The encoder may also be located in the cloud environment separately or as another machine. For example, the encoder 324 may derive starting notification of an advertisement break from an evaluation of embedded data observing a protocol (e.g., SCTE-35). The encoder 324 may derive the starting notification of the an advertisement break by image processing within the content streamed over the network. The encoder 324 may recognize starting notification of the first advertisement break from Hypertext Transport Protocol triggers. Also, the encoder 324 may derive the f-irst advertisement break notification from an advertisement break schedule.

The memory 320 may also store an advertisement proxy 326 corresponding to advertisement proxy 110. The advertisement proxy 326 may also be located in the cloud environment separately or as another machine. The playlist generator 108 requests user-targeted VAST3.0 ad pods from advertisement proxy 110 for each user who is consuming the online live stream at the time of advertisement preparation.

An embodiment of the present invention relates to a computer storage product with a non-transitory computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media, optical media, magneto-optical media and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented by using JavaScript, Ruby, JAVA®, C++, or other functional or object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A machine, comprising:
a processor;
a network interface circuit connected to the processor to communicate with a network; and
a memory connected to the processor, the memory storing instructions executed by the processor to:
receive a first advertisement break notification associated with content streamed over the network,
evaluate a first advertisement segment length,
play a first targeted advertisement,
delay the content streamed over the network by a time offset corresponding to the amount of time that the first targeted advertisement exceeds the first advertisement segment length,
receive a second advertisement break notification associated with the content streamed over the network,
evaluate a second advertisement segment length, and
obtain a second targeted advertisement with a duration of the second advertisement segment length minus the offset.

2. The machine of claim 1 further comprising instructions executed by the processor to find and split live stream segments that coincide with start and finish times of advertisement breaks and encapsulate targeted advertisement sets with newly generated segments.

3. The machine of claim 1 further comprising instructions executed by the processor to slide playlist time rather than keeping segment counts constant such that total duration of segments is greater than or equal to a playlist duration threshold.

4. The machine of claim 1 further comprising instructions executed by the processor to create configurable advertisement breaks for channels that do not include commercial breaks in their linear streams by switching from a live stream to advertisements and then by resuming the live stream from the next segment of the segment placed just before advertisement break.

5. The machine of claim 1 further comprising instructions executed by the processor to download and transcode progressive creative files that are extracted from Video Advertisement Serving Template responses from third party advertisement networks into Hypertext Transport Protocol Live Stream compatible playlists and segments that are uploaded to a content delivery network.

6. The machine of claim 1 further comprising instructions executed by the processor to implement server side dynamic window sliding time shifting without client side input.
